(19) United States
(12) Patent Application Publication
(10) Pub. No.: US 2026/0004493 A1
(43) Pub. Date: Jan. 1, 2026

(54) IMAGE PROCESSING METHOD AND APPARATUS, COMPUTER DEVICE, STORAGE MEDIUM, AND PROGRAM PRODUCT

(71) Applicant: TENCENT TECHNOLOGY (SHENZHEN) COMPANY LIMITED, Shenzhen (CN)

(72) Inventors: Jianxiang LU, Shenzhen (CN); Cong XIE, Shenzhen (CN); Hui GUO, Shenzhen (CN)

(73) Assignee: TENCENT TECHNOLOGY (SHENZHEN) COMPANY LIMITED, Shenzhen (CN)

(21) Appl. No.: 19/320,228

(22) Filed: Sep. 5, 2025

Related U.S. Application Data
(63) Continuation of application No. PCT/CN2024/102912, filed on Jul. 1, 2024.

(30) Foreign Application Priority Data
Aug. 28, 2023 (CN) 202311098890.X

(51) Int. Cl. G06T 11/60; G06T 5/60; G06T 5/70

(52) U.S. Cl. CPC G06T 11/60; G06T 5/60; G06T 5/70; G06T 2207/20081; G06T 2207/20084

(57) ABSTRACT

An image processing method, apparatus, and computer-readable storage medium for training image generation models through semantic-aware denoising. The method obtains sample data including a sample image, its category, and identifier set. Training representation information is extracted from the sample identifier to represent training semantics expressing sample features under the category. A noise image is generated by adding marked noise to the sample image encoding. Based on training representation information, noise in the noise image is predicted. Model parameters are updated using differences between marked and predicted noise and between training semantics of the sample identifier and category semantics. The trained model performs denoising on noise images using text description information including sample identifiers to generate diffusion images.

### CROSS-REFERENCE TO RELATED APPLICATIONS

This application is a continuation application of International Application No. PCT/CN2024/102912 filed on Jul. 1, 2024 which claims priority to Chinese Patent Application No. 202311098890.X, filed with the China National Intellectual Property Administration on Aug. 28, 2023, the disclosures of each being incorporated by reference herein in their entireties.

### FIELD

The disclosure relates to the field of computer technologies, artificial intelligence technologies, an image processing method, an image processing apparatus, a computer device, a computer-readable storage medium, and a computer program product.

### BACKGROUND

With the rapid development of artificial intelligence technologies, an image generation model, which may also be referred to as a diffusion model, has made significant progress in the field of image generation, and creation potential of artificial intelligence is released. An application scenario of the image generation model is usually as follows: A feature, for example, a dog in an image, may be embedded into the image generation model, to generate a diffusion image, for example, the dog in the image stands on a beach, related to the feature. In an ideal situation, a plurality of sample images under the same category may be used to train the image generation model. However, in an actual situation, usually, there is a lack of the plurality of sample images under the same category, and a single sample image is generally used to train the image generation model. However, a problem of overfitting of training usually occurs when the single sample image is used to train the image generation model, leading to a poor training effect of the image generation model.

### SUMMARY

Provided are an image processing method and apparatus, a device, a storage medium, and a program product, which can implement effective image generation model training through semantic-aware denoising using sample identifiers and category information.

According to some embodiments, an image processing method, performed by a computer device, includes: obtaining sample data for training an image generation model, the sample data comprising a sample image, a sample category to which the sample image belongs, and a sample identifier set for the sample image; extracting training representation information of the sample identifier, the training representation information representing training semantics of the sample identifier that express a sample feature of the sample image under the sample category; generating a noise image by adding marked noise to encoding information of the sample image; predicting, based on the training representation information, noise in the noise image to obtain predicted noise; and updating at least one model parameter of the image generation model based on a difference between the marked noise and the predicted noise and a difference between the training semantics of the sample identifier and semantics of the sample category, to train the image generation model, wherein the trained image generation model is configured to perform denoising processing on the noise image based on text description information including the sample identifier, to generate a diffusion image.

According to some embodiments, an image processing apparatus, includes: at least one memory configured to store program code; and at least one processor configured to read the program code and operate as instructed by the program code, the program code including: obtaining code configured to cause at least one of the at least one processor to obtain sample data for training an image generation model, the sample data comprising a sample image, a sample category to which the sample image belongs, and a sample identifier set for the sample image; extracting code configured to cause at least one of the at least one processor to extract training representation information of the sample identifier, the training representation information representing training semantics of the sample identifier that express a sample feature of the sample image under the sample category; generating code configured to cause at least one of the at least one processor to generate a noise image by adding marked noise to encoding information of the sample image; predicting code configured to cause at least one of the at least one processor to predict, based on the training representation information, noise in the noise image to obtain predicted noise; and updating code configured to cause at least one of the at least one processor to update at least one model parameter of the image generation model based on a difference between the marked noise and the predicted noise and a difference between the training semantics of the sample identifier and semantics of the sample category, to train the image generation model, wherein the trained image generation model is configured to perform denoising processing on the noise image based on text description information including the sample identifier, to generate a diffusion image.

According to some embodiments, a non-transitory computer-readable storage medium, storing computer code which, when executed by at least one processor, causes the at least one processor to at least: obtain sample data for training an image generation model, the sample data comprising a sample image, a sample category to which the sample image belongs, and a sample identifier set for the sample image; extract training representation information of the sample identifier, the training representation information representing training semantics of the sample identifier that express a sample feature of the sample image under the sample category; generate a noise image by adding marked noise to encoding information of the sample image; predict, based on the training representation information, noise in the noise image to obtain predicted noise; and update at least one model parameter of the image generation model based on a difference between the marked noise and the predicted noise and a difference between the training semantics of the sample identifier and semantics of the sample category, to train the image generation model, wherein the trained image generation model is configured to perform denoising processing on the noise image based on text description information including the sample identifier, to generate a diffusion image.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of a principle of an image generation model according to some embodiments.

FIG. 2 is a schematic diagram of an architecture of an image generation system according to some embodiments.

FIG. 3 is a schematic flowchart of an image processing method according to some embodiments.

FIG. 4 is a schematic structural diagram of an image generation model in a training stage according to some embodiments.

FIG. 5 is a schematic structural diagram of an image generation model in which a training module is added in a training stage according to some embodiments.

FIG. 6 is a schematic diagram of a process of determining initial representation information of a sample identifier according to some embodiments.

FIG. 7 is a schematic flowchart of another image processing method according to some embodiments.

FIG. 8 is a schematic structural diagram of a trained image generation model according to some embodiments.

FIG. 9 is a schematic structural diagram of another trained image generation model according to some embodiments.

FIG. 10 is a schematic diagram of comparison between image generation effects according to some embodiments.

FIG. 11 is another schematic diagram of comparison between image generation effects according to some embodiments.

FIG. 12 is a schematic structural diagram of an image processing apparatus according to some embodiments.

FIG. 13 is a schematic structural diagram of a computer device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

To more clearly understand the technical solutions provided in some embodiments, key terms involved in some embodiments are first described herein.

Some embodiments relate to an image generation model. The image generation model, also referred to as a diffusion model, refers to a model that can perform diffusion based on a given sample image, a sample category (which may also be referred to as a concept category) to which the sample image belongs, and text description information and based on a sample feature of the sample image under the sample category, to generate a diffusion image related to semantics of the text description information.

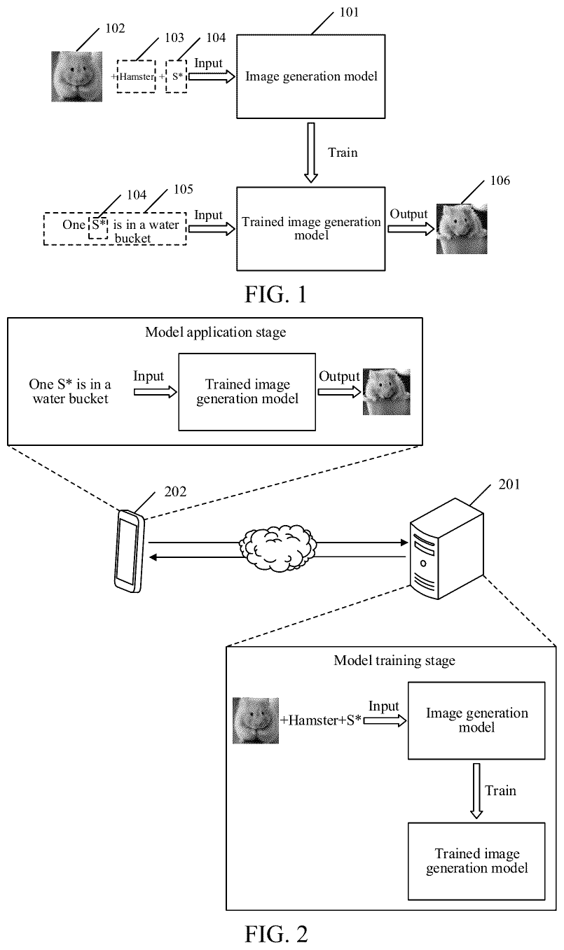

as shown in FIG. 1, for a training principle of an image generation model 101, reference may be roughly made to the following descriptions. A sample image 102 (for example, an image including a hamster in FIG. 1), a sample category 103 (for example, a sample category “hamster” in FIG. 1) to which the sample image 102 belongs, and a sample identifier 104 (for example, a sample identifier “S*” in FIG. 1) set for the sample image 102 are used as input of the image generation model 101. A training target of the image generation model 101 is to improve a similarity between semantics (which may also be referred to as an embedding concept) of the sample identifier 104 extracted by the image generation model 101 and a sample feature of the sample image 102 under the sample category 103. For example, in FIG. 1, the training target of the image generation model 101 is to improve a similarity between semantics of “S*” extracted by the image generation model 101 and a feature of “hamster” in the sample image 102. After training of the image generation model 101 is completed, the semantics of the sample identifier 104 extracted by the trained image generation model 101 can accurately express the sample feature of the sample image 102 under the sample category 103.

As shown in FIG. 1, for an application manner of the image generation model 101, reference may be roughly made to the following descriptions. The input of the trained image generation model 101 is text description information 105 (for example, “one S* in a water bucket” in FIG. 1) including the sample identifier 104. The trained image generation model 101 may perform diffusion based on the semantics of the sample identifier 104 (for example, the sample feature of the sample image 102 under the sample category 103), to generate a diffusion image 106 corresponding to the sample image 102. The generated diffusion image 106 not only may include the sample feature of the sample image 102 under the sample category 103, but also may be related to semantics of other description information (for example, other description information such as “one” or “in a water bucket”) in the text description information 105 other than the sample identifier 104.

The image generation model in some embodiments is a model having a image generation capability, and that the image generation model has the image generation capability means that: based on given description information, the image generation model has a capability of generating an image related to semantics of the given description information. For example, the given description information is “one hamster”, and the image generation model may generate an image including one hamster. Further, the image generation model provided in some embodiments is a pre-trained image generation model. Pre-training enables the image generation model to have the image generation capability. Training the image generation model in some embodiments refers to performing fine tuning on the image generation model, and performing diffusion with reference to the text description information based on the sample feature of the sample image under the sample category by using the image generation capability that the image generation model already has, to generate the diffusion image corresponding to the sample image.

Further, the image generation model in some embodiments may be a machine learning (ML) model related to the field of computer vision (CV) technologies of artificial intelligence (AI).

AI is a theory, a method, a technology, and an application system that uses a digital computer or a machine controlled by the digital computer to simulate, extend, and expand human intelligence, perceive an environment, obtain knowledge, and use the knowledge to obtain an optimal result. In other words, AI is a comprehensive technology in computer science and attempts to understand the essence of intelligence and produce a new intelligent machine that can react in a manner similar to the human intelligence.

The CV technology is a science that studies how to use a machine to “see”, and furthermore, that uses a camera and a computer to replace human eyes to perform machine vision such as recognition and measurement on a target, and further perform graphic processing, so that the computer processes the target into an image more suitable for human eyes to observe, or an image transmitted to an instrument for detection. As a scientific discipline, CV studies related theories and technologies and attempts to establish an AI system that can obtain information from images or multidimensional data.

ML is a multi-field interdisciplinary, and relates a plurality of disciplines such as a probability theory, statistics, an approximation theory, convex analysis, and an algorithm complexity theory. The ML specializes in studying how a computer simulates or implements a human learning behavior to obtain new knowledge or skills, and reorganize an existing knowledge structure, to keep improving its performance. The ML is a core of AI, is a way to make the computer intelligent, and is applied to various fields of AI. The ML and deep learning generally include technologies such as an artificial neural network, a belief network, reinforcement learning, transfer learning, inductive learning, and learning from demonstrations. A pre-training model is a latest development result of the deep learning, and combines the foregoing technologies.

Further, a type of the image generation model is not limited in some embodiments. The image generation model is a model having the image generation capability, and the image generation model may include, but is not limited to, any one of the following: a diffusion probabilistic model (which may be referred to as a diffusion model for short), a denoising diffusion probabilistic model, and a stable-diffusion model.

In a training process of the image generation model, usually, there is a lack of a plurality of sample images under the same category, and a single sample image is generally used to train the image generation model. However, a problem of overfitting of training usually occurs when the single sample image is used to train the image generation model, leading to a poor training effect of the image generation model. Based on this, some embodiments provide an image processing method that can reduce an overfitting degree of the image generation model and improve the training effect of the image generation model. Specifically, in the image processing method provided in some embodiments, the image generation model may be trained based on the difference between the training semantics of the sample identifier (where the training semantics of the sample identifier refers to semantics of the sample identifier in the training process of the image generation model) and the semantics of the sample category. In this way, the similarity between the training semantics of the sample identifier and the semantics of the sample category can be improved. The training semantics of the sample identifier may be configured for expressing the sample feature of the sample image under the sample category. In other words, the similarity between the sample feature of the sample image under the sample category and the semantics of the sample category can be improved. This helps reduce the overfitting degree of the image generation model and improve the training effect of the image generation model. In addition, the image generation model provided in some embodiments may further initialize the training representation information of the sample identifier. The training representation information of the sample identifier refers to representation information that is of the sample identifier and that is extracted in the training process of the image generation model. Initializing the training representation information of the sample identifier refers to searching for initial representation information of the sample identifier that is close to semantics of the sample image and semantics of the sample category to which the sample image belongs, and using the initial representation information as a training starting point of the image generation model. In this way, the image generation model can be quickly guided in a proper training direction, and fitting efficiency of the image generation model and generalization of the image generation model can be improved.

As shown in FIG. 2, an image processing system may include a model training device 201 and a model application device 202. A direct communication connection may be established between the model training device 201 and the model application device 202 in a wired communication manner, or an indirect communication connection may be established between the model training device 201 and the model application device 202 in a wireless communication manner.

The model training device 201 may be configured to train an image generation model. Specifically, a pre-trained image generation model is deployed in the model training device 201. The model training device 201 may train the image generation model (for example, perform fine tuning on the image generation model) based on sample data (where the sample data may include a sample image, a sample category to which the sample image belongs, and a sample identifier set for the sample image), so that training semantics of the sample identifier extracted by the trained image generation model can accurately express a sample feature of the sample image under the sample category. In this way, the trained image generation model can have a capability of performing image diffusion based on the sample feature of the sample image under the sample category.

The model application device 202 may be configured to invoke the trained image generation model to perform image diffusion. Specifically, the trained image generation model may be deployed in the model application device 202. The model application device 202 may generate a diffusion image corresponding to the sample image based on given text description information (where the text description information includes the sample identifier) with the training semantics of the sample identifier (for example, the sample feature of the sample image under the sample category) serving as a basis for diffusion.

The model training device 201 may be a terminal or a server, and the model application device 202 may be a terminal or a server. The terminal mentioned in some embodiments may include any one of the following: a smartphone, a tablet computer, a notebook computer, a desktop computer, an intelligent voice interaction device, a smart watch, a vehicle-mounted terminal, an intelligent home appliance, an aircraft, or the like, but is not limited thereto. The server mentioned in some embodiments may be an independent physical server, or may be a server cluster or a distributed system formed by a plurality of physical servers, or may be a cloud server that provides cloud computing services such as a cloud service, a cloud database, cloud computing, a cloud function, cloud storage, a network service, cloud communication, a middleware service, a domain name service, a security service, a content delivery network (CDN), big data, and an AI platform. This is not limited in some embodiments.

The image processing system shown in FIG. 2 is described by using an example in which the model training device 201 and the model application device 202 are separately set. In an actual application scenario, the model training device 201 and the model application device 202 in the image processing system may be integrated into different devices as shown in FIG. 2. In some embodiments, the model training device 201 and the model application device 202 in the image processing system may be integrated into the same device. For example, the model training device 201 and the model application device 202 may be integrated into the same terminal, or the same server. When the model training device 201 and the model application device 202 in the image processing system are integrated into the same device, an integrated device of the model training device 201 and the model application device 202 not only may be configured to train the image generation model, but also may be configured to invoke the trained image generation model to perform image diffusion.

The image processing system shown in FIG. 2 is intended to describe the technical solutions in some embodiments more clearly, and does not constitute a limitation on the technical solutions provided in some embodiments. A person of ordinary skill in the art may learn that with the evolution of a system architecture and emergence of new service scenarios, the technical solutions provided in some embodiments are also applicable to similar technical problems.

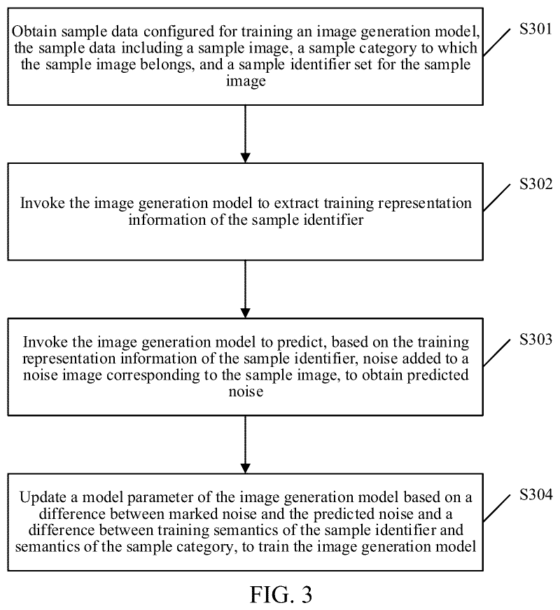

Some embodiments provide an image processing method. The image processing method mainly describes a training process of an image generation model (including content such as a structure of the image generation model, initializing training representation information of a sample identifier, and introducing loss information formed based on a difference between training semantics of the sample identifier and semantics of a sample category). The image processing method may be performed by a computer device. The computer device may be, for example, the foregoing model training device 201 in the image processing system shown in FIG. 2, or may be the integrated device of the model training device 201 and the model application device 202. As shown in FIG. 3, the image processing method may include but is not limited to the following operation S301 to operation S304.

S301: Obtain sample data configured for training an image generation model, the sample data including a sample image, a sample category to which the sample image belongs, and a sample identifier set for the sample image.

The sample data configured for training the image generation model may include: the sample image, the sample category to which the sample image belongs, and the sample identifier set for the sample image. The sample image is a single image configured for training the image generation model. The sample category to which the sample image belongs refers to a category to which the sample image belongs, and the sample category to which the sample image belongs may be set based on a task type of an image generation task. If the task type of the image generation task is performing image diffusion based on the whole sample image, the sample category to which the sample image belongs may be a category to which the whole sample image belongs, for example, “landscape painting” or “oil painting”. If the task type of the image generation task is performing image diffusion based on a sample object in the sample image, the sample category to which the sample image belongs may be a sample category to which the sample object in the sample image belongs, for example, “dog” or “hamster”. An objective of setting the sample identifier for the sample image is to expect training semantics of the sample identifier extracted by the trained image generation model to accurately express a sample feature of the sample image under the sample category. In this way, in an application stage of the trained image generation model, a good diffusion effect on the sample image can be achieved based on text description information including the sample identifier.

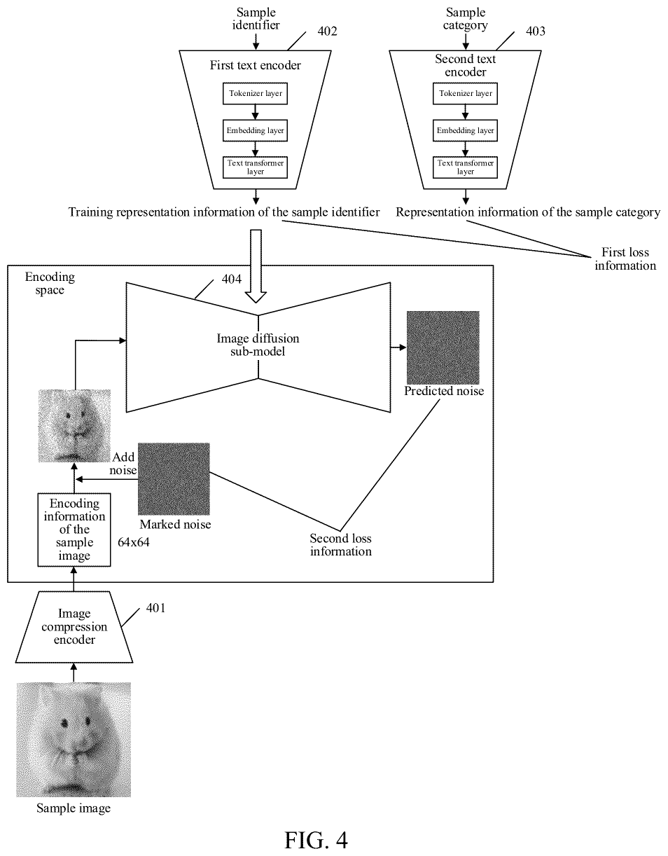

A training process of the image generation model is described in operation S302 to operation S304 in some embodiments. A structure of the image generation model in a model training stage is first described herein with reference to FIG. 4. In this way, when the training process of the image generation model is described in operation S302 to operation S304, reference may be made to the structure of the image generation model shown in FIG. 4. As shown in FIG. 4, the image generation model may include at least an image compression encoder 401, a first text encoder 402, a second text encoder 403, and an image diffusion sub-model 404.

(1) Image compression encoder 401: The image compression encoder may be configured to convert an image (for example, the sample image) from a pixel space to an encoding space (the encoding space may also be referred to as a latent space). Converting the image from the pixel space to the encoding space refers to performing encoding processing on the image, to obtain encoding information of the sample image. The pixel space refers to a range formed by the image that is represented in a form of a pixel. The encoding space refers to a range formed by the encoding information of the image. The encoding processing refers to compression processing. The encoding information refers to compression information of the image. In addition, noise addition processing may be performed on the sample image in the encoding space. Specifically, after the image compression encoder converts the sample image from the pixel space to the encoding space to obtain the encoding information of the sample image, noise addition processing may be performed on the encoding information of the sample image, to obtain a noise adding image corresponding to the sample image. The noise addition processing refers to adding noise.

A type of the image compression encoder is not limited in some embodiments. Some embodiments is described by using an example in which the image compression encoder is a compression encoder in a variational autoencoder (VAE).

(2) First text encoder 402: The first text encoder may be configured to extract the training representation information of the sample identifier, and the training representation information of the sample identifier may be configured for representing the training semantics of the sample identifier. A type of the first text encoder is not limited in some embodiments. Some embodiments is described by using an example in which the first text encoder is a text encoder in a contrastive language-image pre-training (CLIP) model.

(3) Second text encoder 403: The second text encoder may be configured to extract representation information of the sample category, and the representation information of the sample category may be configured for representing the semantics of the sample category. A type of the second text encoder is not limited in some embodiments. Some embodiments is described by using an example in which the second text encoder is a text encoder in the CLIP model.

(4) Image diffusion sub-model (UNet) 404: In a training stage of the image generation model, the image diffusion sub-model may be configured to predict, based on the training representation information of the sample identifier, noise added to a noise image corresponding to the sample image, to obtain encoding information of predicted noise.

Based on related descriptions about the structure of the image generation model in some embodiments shown in FIG. 4, an approximate training principle of the image generation model is: 1. invoking the image compression encoder 401 to convert the sample image from the pixel space to the encoding space, to obtain the encoding information of the sample image, and performing, in the encoding space, noise addition processing on the encoding information of the sample image, to obtain the noise adding image corresponding to the sample image, where noise added in the noise addition processing is marked noise; 2. invoking the first text encoder 402 to extract the training representation information of the sample identifier, where the training representation information of the sample identifier may be configured for representing the training semantics of the sample identifier, and invoking the second text encoder 403 to extract the training representation information of the sample category, where the representation information of the sample category may be configured for representing the semantics of the sample category; 3. invoking the image diffusion sub-model 404 to predict, based on the training representation information of the sample identifier, the noise added to the noise image corresponding to the sample image, to obtain the predicted noise; and 4. updating a parameter of the image generation model based on a difference between the predicted noise and the marked noise, and a difference between the training representation information of the sample identifier and the representation information of the sample category (for example, a difference between the training semantics of the sample identifier and the semantics of the sample category), to train the image generation model. The foregoing 1 to 4 describe any training process of the image generation model. Iterative training may be performed on the image generation model based on the foregoing 1 to 4, until a training termination condition is satisfied, to obtain the trained image generation model. A case in which the training termination condition is satisfied may include any one of the following: A quantity of times of the iterative training reaches a quantity of times threshold (where the quantity of times threshold may a value that is set based on an empirical value and is configured for controlling the quantity of times of training, for example, the quantity of times threshold is 100), and loss information of the image generation model is less than a loss threshold (where the loss threshold may be a value that is set based on an empirical value and is configured for controlling the loss information of the image generation model).

After the structure of the image generation model and the approximate training principle of the image generation model are described with reference to FIG. 4, the following describes the training process of the image generation model in detail with reference to operation S302 to operation S304.

S302: Invoke the image generation model to extract the training representation information of the sample identifier.

In operation S302, the invoking the image generation model to extract the training representation information of the sample identifier is invoking a text encoder (where the text encoder herein is referred to as the first text encoder) in the image generation model to extract the training representation information of the sample identifier. The training representation information of the sample identifier may be configured for representing the training semantics of the sample identifier, and the training semantics of the sample identifier may be configured for expressing the sample feature of the sample image under the sample category.

Specifically, as shown in FIG. 4, the text encoder may include a tokenizer layer, an embedding layer, and a text transformer layer. The tokenizer layer may be invoked to perform word segmentation processing on the sample identifier, to obtain one or more segmented words included in the sample identifier. The tokenizer layer may be invoked to map each segmented word to a token corresponding to each segmented word. The token is a number that can be recognized by a computer device. The embedding layer may be invoked to convert the token of each segmented word to a corresponding embedding vector. The text transformer layer may be invoked to perform semantic understanding on the embedding vector of each segmented word, to obtain the training representation information of the sample identifier.

S303: Invoke the image generation model to predict, based on the training representation information of the sample identifier, the noise added to the noise image corresponding to the sample image, to obtain the predicted noise.

In operation S303, the image generation model is invoked to predict, based on the training representation information of the sample identifier, the noise added to the noise image corresponding to the sample image, to obtain the predicted noise. Specifically, an image diffusion sub-model in the image generation model is invoked to predict, based on the training representation information of the sample identifier, the noise added to the noise image corresponding to the sample image, to obtain the predicted noise. As described above, the noise image corresponding to the sample image is obtained by performing noise addition processing on the encoding information of the sample image in the encoding space after the sample image is converted from the pixel space to the encoding space. A process of predicting noise also occurs in the encoding space. In other words, in the encoding space, the image generation model (the image diffusion sub-model in the image generation model) may be invoked to predict, based on the training representation information of the sample identifier, the noise added to the noise image, to obtain the predicted noise. In a training process of an image processing model in some embodiments, the sample image is converted from the pixel space to the encoding space, noise addition processing is performed on the sample image in the encoding space, and noise is predicted in the encoding space for the noise adding image corresponding to the sample image. This is because a dimension of the pixel space is higher than a dimension of the encoding space. If noise addition processing is performed on the sample image in the encoding space, and noise is predicted in the encoding space for the noise adding image corresponding to the sample image, a data amount processed during the noise addition processing and the noise prediction can be reduced, and efficiency of the noise addition processing and the noise prediction can be improved, thereby improving training efficiency of the image generation model to some extent.

Further, the image diffusion sub-model may include N cross-attention modules, and any one of the N cross-attention modules may be represented as an i^{th} cross-attention module. N is an integer greater than or equal to 2, and i is a positive integer less than or equal to N. The process of invoking, in the encoding space, the image generation model (the image diffusion sub-model in the image generation model) to predict, based on the training representation information of the sample identifier, the noise added to the noise image, to obtain the predicted noise may include: invoking, when i is equal to 1, the i^{th} cross-attention module to perform correlation calculation on the training representation information of the sample identifier and the noise image, to obtain a cross-attention result of the i^{th} cross-attention module, where the correlation calculation herein refers to calculating a similarity between the training representation information of the sample identifier and the noise image, and using the similarity as the cross-attention result of the i^{th} cross-attention module; invoking, when i is greater than 1, the i^{th} cross-attention module to perform correlation calculation on a cross-attention result of an (i−1)^{th} cross-attention module and the training representation information of the sample identifier, to obtain the cross-attention result of the i^{th} cross-attention module; and determining a cross-attention result of an Nth cross-attention module as the predicted noise, where the correlation calculation herein refers to calculating a similarity between the cross-attention result of the (i−1)^{th} cross-attention module and the training representation information of the sample identifier, and using the similarity as the cross-attention result of the i^{th} cross-attention module.

S304: Update a model parameter of the image generation model based on the difference between the marked noise and the predicted noise and the difference between the training semantics of the sample identifier and the semantics of the sample category, to train the image generation model.

After the image generation model is invoked to predict, based on the training representation information of the sample identifier, the noise added to the noise image corresponding to the sample image, to obtain the predicted noise, the model parameter of the image generation model may be updated based on the difference between the marked noise and the predicted noise and the difference between the training semantics of the sample identifier and the semantics of the sample category, to train the image generation model. Specifically, a process of updating the model parameter of the image generation model based on the difference between the marked noise and the predicted noise and the difference between the training semantics of the sample identifier and the semantics of the sample category, to train the image generation model may include:
(1) First loss information may be determined based on the difference between the marked noise and the predicted noise. For details about the first loss information, refer to Formula 1:

$${L}_{LDM} = {E}_{ε ( x )} , y , ϵ \sim N ( 0 , 1 ) , t [ {‖ ϵ - {ϵ}_{θ} ( {z}_{t} , t , c ) ‖}^{2} ] \qquad Formula 1$$

In Formula 1, L_{LDM} represents the first loss information; x represents the sample image; c represents the training representation information of the sample identifier; t represents a time step; ∈ represents the marked noise; ∈_{θ} represents the predicted noise; and zₜ represents the noise image corresponding to the sample image obtained by performing noise addition processing on the encoding information of the sample image in the encoding space within the time step t.

(2) Second loss information may be determined based on the difference between the training representation information of the sample identifier and the representation information of the sample category (for example, the difference between the training semantics of the sample identifier and the semantics of the sample category). For details about the second loss information, refer to Formula 2:

$${L}_{CL} = 1 - {α}_{cl} \frac{T ( {c}_{p} ) T ( {c}_{c} )}{‖ T ( {c}_{p} ) ‖ ‖ T ( {c}_{c} ) ‖} \qquad Formula 2$$

In Formula 2, L_{CL} represents the second loss information; T represents the text encoder (including the first text encoder or the second text encoder); cₚ represents the sample identifier; T(cₚ) represents the training representation information of the sample identifier extracted when the text encoder (where the text encoder herein refers to the first text encoder) is invoked; c_{c} represents the sample category; T(c_{c}) represents representation information of the sample category extracted when the text encoder (where the text encoder herein refers to the second text encoder) is invoked; and α_{cl} represents a weight parameter. A specific parameter value of the weight parameter is not limited in some embodiments. The specific parameter value of the weight parameter may be set based on an empirical value. For example, the parameter value of the weight parameter is set to 1.

The representation information of the sample category may be extracted when the text encoder (where the text encoder herein refers to the second text encoder) in the image generation model is invoked. A process in which the second text encoder extracts the representation information of the sample category is similar to a process in which the first text encoder extracts the training representation information of the sample identifier in the foregoing operation S302. For details, refer to the process in which the first text encoder extracts the training representation information of the sample identifier in the foregoing operation S302. Details are not described herein again. The representation information of the sample category may be configured for representing the semantics of the sample category.

(3) Weighted summation processing may be performed on the first loss information and the second loss information, to obtain the loss information of the image generation model. A specific weight value of a first weight configured for weighting the first loss information and a specific weight value of a second weight configured for weighting the second loss information are not limited in some embodiments. The specific weight value of the first weight and the specific weight value of the second weight may be determined based on an empirical value. For example, both the weight value of the first weight and the weight value of the second weight may be set to 1. For another example, the weight value of the first weight may be set to 1, and the weight value of the second weight may be set to 0.5. The model parameter of the image generation model may be updated in a direction of minimizing the loss information of the image generation model, to train the image generation model.

Further, when the model parameter of the image generation model is updated in the direction of minimizing the loss information of the image generation model, there may be two manners of updating the model parameter of the image generation model. A first update manner is directly updating the model parameter of the image generation model, in other words, an original model parameter of the image generation model may be updated in the direction of minimizing the loss information of the image generation model, to train the image generation model. A second update manner is adding a training module to the image generation model, keeping the original model parameter of the image generation model unchanged, and updating a model parameter of the training module, in other words, keeping the original model parameter of the image generation model unchanged and updating the model parameter of the training module in the direction of minimizing the loss information of the image generation model, to train the image generation model. The following describes the first update manner and the second update manner in detail.

In the first update manner, a model parameter of the first text encoder and the image diffusion sub-model in the image generation model may be updated in the direction of minimizing the loss information of the image generation model, and a model parameter of the image compression encoder and the second text encoder is kept unchanged, to train the image generation model. In other words, essence of training the image generation model in this application is training the first text encoder and the image diffusion sub-model in the image generation model.

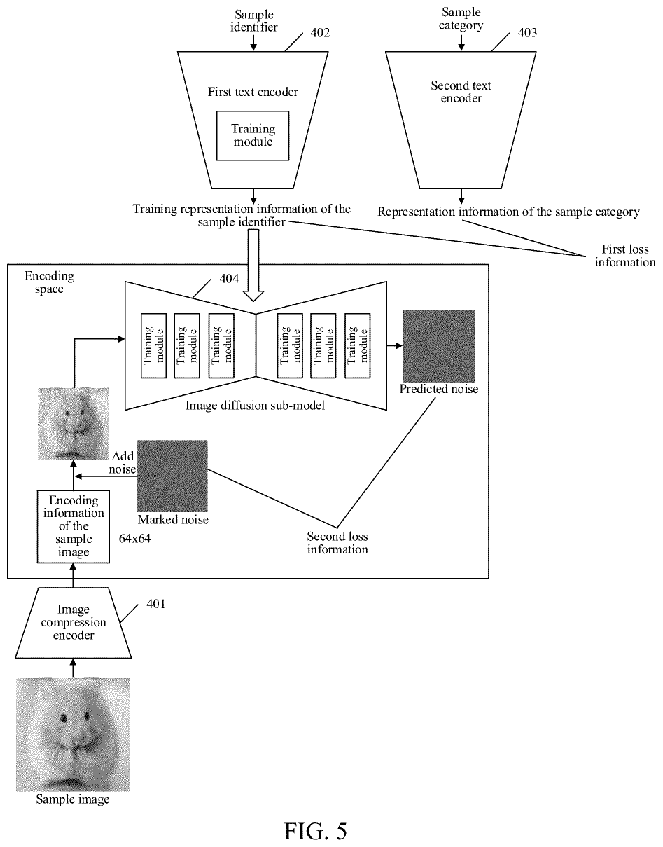

In a second update manner, as shown in FIG. 5, a training module (LoRA module) may be added to the image generation model, and the training module may be added to the text encoder (where the text encoder herein refers to the first text encoder) that is configured to extract the training representation information of the sample identifier, and may be added to the image diffusion submodule. For the text encoder, the training module may be added to the text transformer layer of the text encoder. The training module may be configured to perform dimension reduction processing on the training representation information of the sample identifier output by the text transformer layer, and then restore a dimension of the training representation information of the sample identifier to an original dimension of the training representation information of the sample identifier through dimension increase processing. For the image diffusion sub-model, the image diffusion sub-model may include a plurality of cross-attention modules. The training module may be added to a linear layer of each cross-attention module. The training module may be configured to perform dimension reduction processing on a result output by the linear layer, and then restore a dimension of the result to an original dimension of the result through dimension increase processing. Based on this, an original model parameter in the text encoder and the image diffusion sub-model may be kept unchanged, and a model parameter of the training module added to the text encoder and the image diffusion sub-model is updated in the direction of minimizing the loss information of the image generation model, to train the image generation model. In other words, the essence of training the image generation model in this application is training the training module added to the first text encoder and the image diffusion sub-model of the image generation model.

In operation S304, the model parameter of the image generation model is updated based on the difference between the training semantics of the sample identifier and the semantics of the sample category, to train the image generation model. This can improve a similarity between the training semantics of the sample identifier and the semantics of the sample category, and associate the training semantics of the sample identifier with the semantics of the sample category, to better use prior knowledge of the image generation model (for example, the semantics of the sample category). In this way, an overfitting degree of the image generation model can be reduced, and a training effect of the image generation model can be improved. In the first update manner, directly updating the original model parameter of the image generation model can reduce the overfitting degree of the image generation model and improve the training effect of the image generation model. However, generally, the model parameter of the image generation model is large, and if the original model parameter of the image generation model is directly updated, some model training efficiency may be lost. However, in the second update manner, in comparison to the original model parameter of the image generation model, a quantity of model parameters of the training module is small. Updating the model parameter of the training module can reduce the overfitting degree of the image generation model, improve the training effect of the image generation model, and further improve the model training efficiency to some extent.

In the foregoing operation S301 to operation S304, training operations of extracting the training representation information of the sample identifier, predicting the noise added to the noise image, and updating the model parameter of the image generation model may be configured for training the image generation model once. Iterative training may be performed on the image generation model based on the foregoing training operations until a training termination condition is satisfied, to obtain the trained image generation model. In an iterative training process of the image generation model, initial representation information of the sample identifier is used as a training starting point. The initial representation information of the sample identifier may be determined by minimizing a difference among semantics of the sample image, the semantics of the sample category, and native semantics of the sample identifier. The training starting point may refer to: using the initial representation information of the sample identifier as the training representation information of the sample identifier, to participate in a first training process of the image generation model. The difference among the semantics of the sample image, the semantics of the sample category, and the native semantics of the sample identifier is minimized, so that the training semantics of the sample identifier represented by the determined initial representation information of the sample identifier can be close to the semantics of the sample image and the semantics of the sample category. The initial representation information of the sample identifier is used to participate in the first training on the image generation model. In this way, the image generation model can be quickly guided in a proper training direction, and fitting efficiency of the image generation model and generalization of the image generation model can be improved.

Further, the semantics of the sample image may be represented by using representation information of the sample image. The representation information of the sample image may be obtained by performing semantic understanding on the sample image by using an image semantic encoder. In some embodiments, a type of the image semantic encoder is not limited. An example in which the image semantic encoder is an image encoder in a CLIP model is used in some embodiments for description. The image semantic encoder may be a trained image encoder and already has a semantic understanding capability. The semantics of the sample category may be represented by using the representation information of the sample category, and the representation information of the sample category may be extracted by using the second text encoder of the image generation model. The native semantics of the sample identifier is semantics of the sample identifier before the image generation model is trained. The native semantics of the sample identifier may be represented by using native representation information of the sample identifier. The native representation information of the sample identifier may be extracted for the first time by using the first text encoder of the image generation model. The extraction for the first time refers to extraction performed by using the first text encoder before training. In other words, the native representation information is representation information of the sample identifier extracted before the image generation model is trained. Based on this, a process in which the initial representation information of the sample identifier is determined by minimizing the difference among the semantics of the sample image, the semantics of the sample category, and the native semantics of the sample identifier may include: extracting the representation information of the sample image, where the representation information of the sample image may be configured for representing the semantics of the sample image; extracting the representation information of the sample category, where the representation information of the sample category may be configured for representing the semantics of the sample category; performing averaging processing on the representation information of the sample image and the representation information of the sample category, to obtain average representation information; and extracting the native representation information of the sample identifier, and determining the initial representation information of the sample identifier by minimizing a distance between the native representation information of the sample identifier and the average representation information.

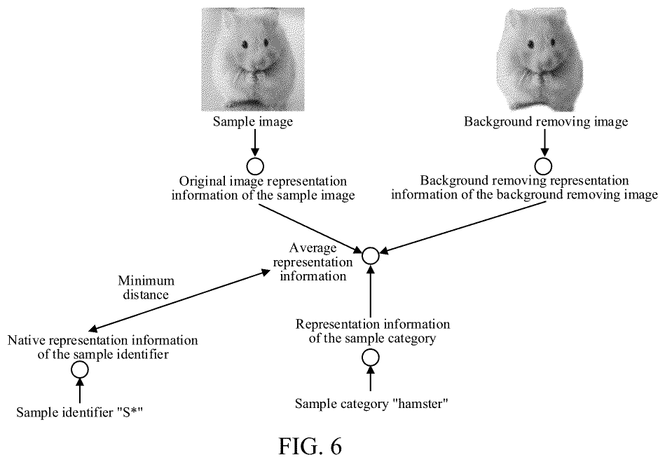

In some embodiments, the representation information of the sample image may include original image representation information of the sample image and background removing representation information of a background removing image corresponding to the sample image. Specifically, the original image representation information of the sample image may be extracted. The original image representation information of the sample image may be configured for representing original image semantics of the sample image. The original image representation information of the sample image may be obtained by performing semantic understanding on the sample image by using the image semantic encoder. The background removing representation information of the background removing image corresponding to the sample image may be extracted. The background removing representation information may be configured for representing semantics of the background removing image. The background removing image may be obtained by removing a background of the sample image. The background removing representation information may be obtained by performing semantic understanding on the background removing image by using the image semantic encoder. The original image representation information and the background removing representation information may be determined as the representation information of the sample image. Further, as shown in FIG. 6, averaging processing may be performed on the original image representation information of the sample image (for example, an image including a hamster and a background in FIG. 6), the background removing representation information of the background removing image (for example, an image including a hamster but not including a background in FIG. 6) corresponding to the sample image, and the representation information of the sample category (for example, a sample category “hamster” in FIG. 6), to obtain the average representation information. The native representation information of the sample identifier (for example, a sample identifier “S*” in FIG. 6) may be extracted, and the initial representation information of the sample identifier is determined by minimizing the distance between the native representation information of the sample identifier and the average representation information. For details, refer to Formula 3:

$${L}_{PE} = 1 - \frac{T ( {c}_{p} ) {θ}_{m} ( I ( x ) , I ( {x}_{m} ) , T ( {c}_{c} ) )}{‖ T ( {c}_{p} ) ‖ ‖ {θ}_{m} ( I ( x ) , I ( {x}_{m} ) , T ( {c}_{c} ) ‖} \qquad Formula 3$$

In Formula 3, L_{PE} represents the initial representation information of the sample identifier; T represents the text encoder (including the first text encoder or the second text encoder); cₚ represents the sample identifier; T(cₚ) represents the native representation information of the sample identifier extracted when the text encoder (where the text encoder herein refers to the first text encoder) is invoked; c_{c} represents the sample category; T(c_{c}) represents the representation information of the sample category extracted when the text encoder (where the text encoder herein refers to the second text encoder) is invoked; x represents the sample image; xₘ represents the background removing image corresponding to the sample image; I represents the image semantic encoder; I(x) represents the representation information of the sample image that is obtained when the image semantic encoder is invoked to perform semantic understanding on the sample image; I(xₘ) represents the background removing representation information of the background removing image that is obtained when the image semantic encoder is invoked to perform semantic understanding on the background removing image corresponding to the sample image; θₘ represents a rule or an algorithm used for averaging processing; and θₘ(I(x), I(xₘ), T(c_{c})) represents the average representation information.

It can be easily learnt that, in a manner in which the background removing image corresponding to the sample image is not introduced when the initial representation information of the sample identifier is determined, more attention is paid to the whole sample image. This manner is more applicable to an image generation task of performing image diffusion based on the whole sample image. In manner in which the background removing image corresponding to the sample image is introduced when the initial representation information of the sample identifier is determined, attention is not only paid to the whole sample image, but also paid to a sample object in the sample image (generally, a background removing image obtained after background removing processing is performed on the sample image includes the sample object in the sample image). This manner is more applicable to an image generation task of performing image diffusion based on the sample object in the sample image. In other words, the initial representation information of the sample identifier may be determined based on a determining manner corresponding to a task type of the image generation task. In this way, the image generation model that is trained based on the initial representation information of the sample identifier can be more adapted to the image generation task.

In the iterative training process of the image generation model, noise images corresponding to the sample image used in each training process of the image generation model may be different. That the noise images corresponding to the sample image are different may mean that: marked noise added when noise addition processing is performed on the sample image in each training process of the image generation model is different. That the marked noise is different may include any one of the following: The marked noise added in each training process of the image generation model is of different types (for example, marked noise added in a first training process is Gaussian noise and marked noise added in a second training process is Gamma noise), and the marked noise added in each training process of the image generation model is of the same type but has different strength (for example, the marked noise added in each training process is Gaussian noise, and strength of the Gaussian noise gradually increases as a quantity of times of training increases). Different noise images are used in each training process of the image generation model (for example, noise addition processing is performed by using different marked noise), so that the image generation model can be trained to achieve a good image generation effect for different noise images, thereby helping improve the training effect of the image generation model.

In some embodiments, in the training process of the image generation model, the initial representation information of the sample identifier is determined in the first training process of the image generation model by minimizing the difference among the semantics of the sample image, the semantics of the sample category, and the native semantics of the sample identifier. In this way, the training semantics of the sample identifier represented by the determined initial representation information of the sample identifier can be close to the semantics of the sample image and the semantics of the sample category. The initial representation information of the sample identifier is used to participate in the first training on the image generation model. In this way, the image generation model can be quickly guided in the proper training direction, and the fitting efficiency of the image generation model and the generalization of the image generation model can be improved. The model parameter of the image generation model is updated based on the difference between the training semantics of the sample identifier and the semantics of the sample category, to train the image generation model. This can improve the similarity between the training semantics of the sample identifier and the semantics of the sample category, and associate the training semantics of the sample identifier with the semantics of the sample category, to better use the prior knowledge (for example, the semantics of the sample category) of the image generation model. In this way, the overfitting degree of the image generation model can be reduced, and the training effect of the image generation model can be improved.

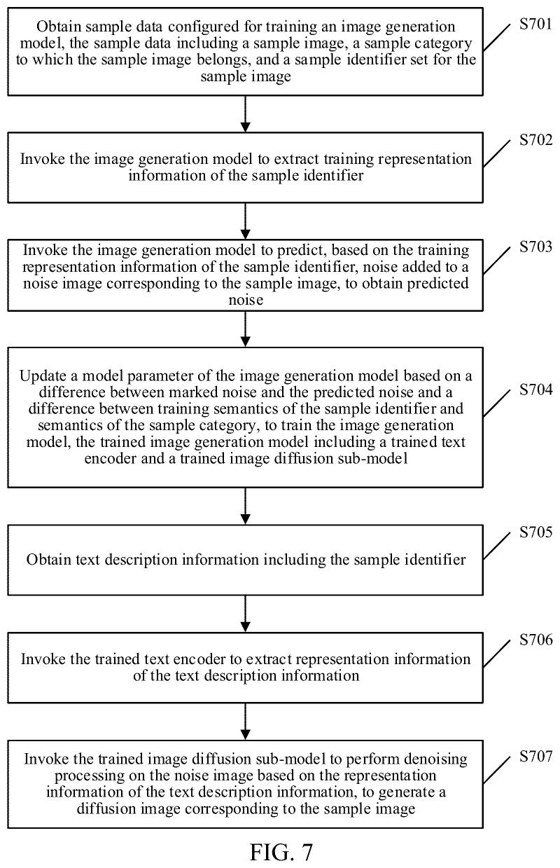

Some embodiments provide an image processing method. The image processing method mainly describes an application process of a trained image generation model (including content such as an image diffusion process based on text description information, and a specific application scenario of the trained image generation model). The image processing method may be performed by a computer device. The computer device may be, for example, an integrated device of a model training device 201 and a model application device 202, or the image processing method may be cooperatively performed by the model training device 201 and the model application device 202. In some embodiments, devices that cooperatively perform the image processing method are collectively referred to as the computer devices. As shown in FIG. 7, the image processing method may include but is not limited to the following operation S701 to operation S707.

S701: Obtain sample data configured for training an image generation model, the sample data including a sample image, a sample category to which the sample image belongs, and a sample identifier set for the sample image.

In some embodiments, an execution process of operation S701 is the same as an execution process of operation S301 in the foregoing embodiment shown in FIG. 3. For a specific execution process, refer to related descriptions of operation S301 in the foregoing embodiment shown in FIG. 3. Details are not described herein again.

S702: Invoke the image generation model to extract training representation information of the sample identifier.

In some embodiments, an execution process of operation S702 is the same as an execution process of operation S302 in the foregoing embodiment shown in FIG. 3. For a specific execution process, refer to related descriptions of operation S302 in the foregoing embodiment shown in FIG. 3. Details are not described herein again.

S703: Invoke the image generation model to predict, based on the training representation information of the sample identifier, noise added to a noise image corresponding to the sample image, to obtain predicted noise.

In some embodiments, an execution process of operation S703 is the same as an execution process of operation S303 in the foregoing embodiment shown in FIG. 3. For a specific execution process, refer to related descriptions of operation S303 in the foregoing embodiment shown in FIG. 3. Details are not described herein again.

S704: Update a model parameter of the image generation model based on a difference between marked noise and the predicted noise and a difference between training semantics of the sample identifier and semantics of the sample category, to train the image generation model, the trained image generation model including a trained text encoder and a trained image diffusion sub-model.

In some embodiments, an execution process of operation S704 is the same as an execution process of operation S304 in the foregoing embodiment shown in FIG. 3. For a specific execution process, refer to related descriptions of operation S304 in the foregoing embodiment shown in FIG. 3. Details are not described herein again.

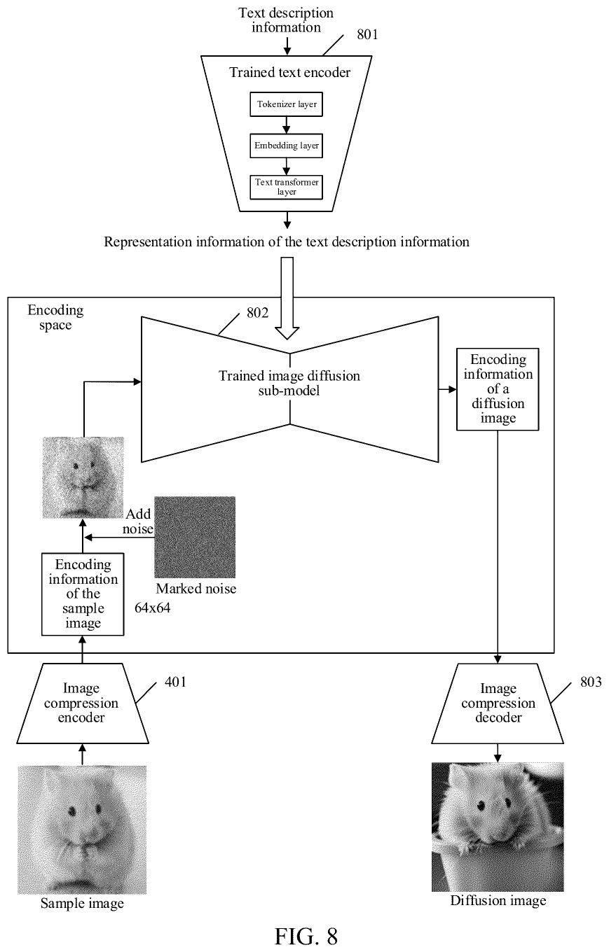

In some embodiments, in operation S705 to operation S707, an application process of the trained image generation model is described. A structure of the trained image generation model is first described herein with reference to FIG. 8. In this way, when operation S705 to operation S707 are described, reference may be made to the structure of the trained image generation model. When the application process of the trained image generation model is described in detail in operation S705 to operation S707, reference may be made to the structure of the trained image processing model shown in FIG. 8. The structure of the trained image generation model is similar to the structure of the image generation model in the model training stage shown in FIG. 4. As shown in FIG. 8, the trained image generation model may include at least an image compression encoder 401, a trained text encoder 801 (where the trained text encoder mentioned herein refers to a trained first text encoder), a trained image diffusion sub-model 802, and an image compression decoder 803.

(1) Image compression encoder 401: The image compression encoder may be configured to convert the sample image from a pixel space to an encoding space, to obtain encoding information of the sample image. In addition, noise addition processing may be performed on the sample image in the encoding space. Specifically, after an image semantic encoder converts the sample image from the pixel space to the encoding space to obtain the encoding information of the sample image, noise addition processing may be performed on the encoding information of the sample image, to obtain a noise adding image corresponding to the sample image.

(2) Trained first text encoder 801: The trained first text encoder may be configured to extract representation information of text description information. The text description information may include the sample identifier, and the representation information of the text description information may be configured for representing semantics of the text description information.

(3) Trained image diffusion sub-model 802: In an application stage of the trained image generation model, the trained image diffusion sub-model may be configured to perform, based on the representation information of the text description information, denoising processing on the noise image corresponding to the sample image, to obtain encoding information of a diffusion image corresponding to the sample image. The denoising processing refers to removing noise from the noise image.

(4) Image compression decoder 803: A decoding process of the image compression decoder and an encoding process of the image compression encoder are mutually inverse processes. In the application stage of the trained image generation model, the image compression decoder may be configured to convert the encoding information of the diffusion image from the encoding space to the pixel space, to obtain the diffusion image. Converting the encoding information of the diffusion image from the encoding space to the pixel space refers to performing decoding processing on the encoding information of the diffusion image, and the decoding processing refers to decompression processing.

A type of the image compression decoder is not limited in some embodiments. Some embodiments is described by using an example in which the image compression decoder is a compression decoder in a variational autoencoder (VAE).

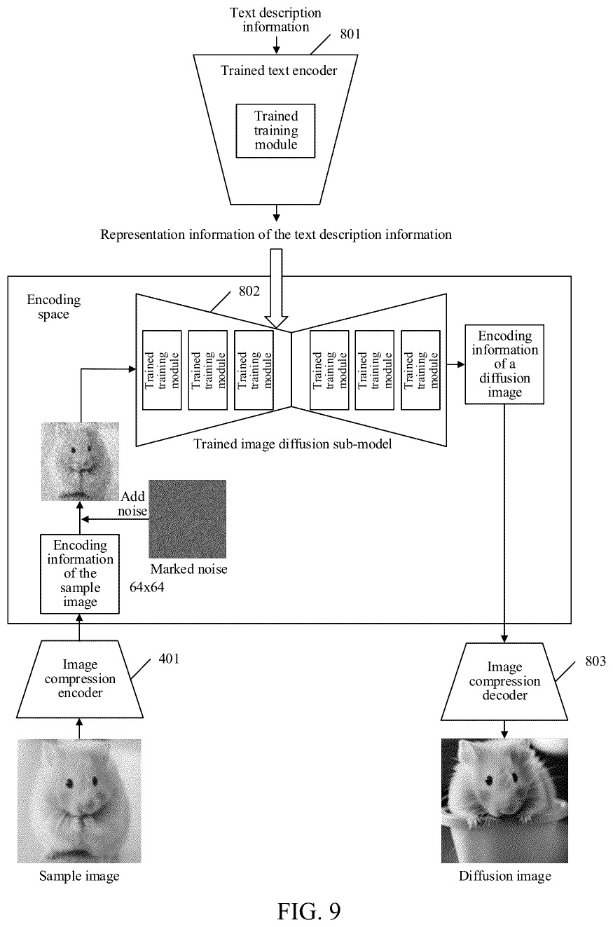

Corresponding to a training stage of the image generation model, if no training module is added to the image generation model in a training process, for example, if an original model parameter of the image generation model is directly updated when the model parameter is updated, the structure of the trained image generation model is shown in FIG. 8. If a training module is added to the image generation model in the training process, for example, if the original model parameter of the image generation model is kept unchanged, and a model parameter of the added training module is updated when the model parameter is updated, the structure of the trained image generation model is shown in FIG. 9. A difference between FIG. 8 and FIG. 9 lies in that, in the structure of the trained image generation model shown in FIG. 9, a trained training module is added to the trained text encoder (where the trained text encoder herein refers to the trained first text encoder) and the trained image diffusion sub-model. Corresponding to the training stage of the image generation model, the trained training module may be added to a text transformer layer of the trained text encoder. The trained training module may be configured to perform dimension reduction processing on the representation information of the text description information output by the text transformer layer, and then restore a dimension of the representation information of the text description information to an original dimension of the representation information of the text description information through dimension increase processing. The trained image diffusion sub-model may include a plurality of cross-attention modules. The trained training module may be added to a linear layer of each cross-attention module. The trained training module may be configured to perform dimension reduction processing on a result output by the linear layer, and then restore a dimension of the result to an original dimension of the result through dimension increase processing.

Based on the foregoing related descriptions about the structure of the trained image generation model, an approximate application process of the trained image generation model may be: 1. invoking the image compression encoder 401 to convert the sample image from the pixel space to the encoding space, to obtain the encoding information of the sample image, and performing, in the encoding space, noise addition processing on the sample image, to obtain the noise adding image corresponding to the sample image; 2. invoking the trained first text encoder 801 to extract the representation information of the text description information, where the text description information includes the sample identifier, and the representation information of the text description information may be configured for representing the semantics of the text description information; 3. invoking the trained image diffusion sub-model 802 to perform, based on the representation information of the text description information, denoising processing on the noise image corresponding to the sample image, to obtain the encoding information of the diffusion image corresponding to the sample image; and 4. invoking the image compression decoder 803 to convert the encoding information of the diffusion image from the encoding space to the pixel space, to obtain the diffusion image, where the diffusion image is related to the semantics of the text description information, and that the diffusion image is related to the semantics of the text description information herein means that image content of the diffusion image can express the semantics of the text description information.

After the structure of the trained image generation model and the application process of the trained image generation model are described with reference to FIG. 8 and FIG. 9, the following describes the application process of the trained image generation model in detail with reference to operation S705 to operation S707.

S705. Obtain text description information including the sample identifier.

S706: Invoke the trained text encoder to extract the representation information of the text description information.

In operation S706, a process of invoking the trained text encoder to extract the representation information of the text description information is similar to the process of invoking the first text encoder to extract the training representation information of the sample identifier in the foregoing embodiment shown in FIG. 3. Specifically, the trained text encoder may include a tokenizer layer, an embedding layer, and a text transformer layer. The tokenizer layer may be invoked to perform word segmentation processing on the text description information, to obtain one or more segmented words included in the text description information. The tokenizer layer may be invoked to map each segmented word to a token corresponding to each segmented word. The token is a number that can be recognized by a computer device. The embedding layer may be invoked to convert the token of each segmented word to a corresponding embedding vector. The text transformer layer may be invoked to perform semantic understanding on the embedding vector of each segmented word, to obtain the representation information of the text description information.

S707: Invoke the trained image diffusion sub-model to perform denoising processing on the noise image based on the representation information of the text description information, to generate the diffusion image corresponding to the sample image.

As described above, the noise image corresponding to the sample image is obtained by performing noise addition processing on the encoding information of the sample image in the encoding space after the sample image is converted from the pixel space to the encoding space. A process of denoising processing also occurs in the encoding space. In other words, in the encoding space, the trained image diffusion sub-model may be invoked to perform denoising processing on the noise image based on the representation information of the text description information, to obtain the encoding information of the diffusion image corresponding to the sample image. The image compression decoder may be invoked to convert the encoding information of the diffusion image from the encoding space to the pixel space, to obtain the diffusion image. The diffusion image is related to the semantics of the text description information. In the application process of the trained image processing model in some embodiments, the sample image is converted from the pixel space to the encoding space, noise addition processing is performed on the sample image in the encoding space, and denoising processing is performed on the noise adding image corresponding to the sample image in the encoding space. This is because a dimension of the pixel space is higher than a dimension of the encoding space. If noise addition processing is performed on the sample image in the encoding space, and denoising processing is performed on the noise adding image corresponding to the sample image in the encoding space, a data amount processed during the noise addition processing and the denoising processing can be reduced, and efficiency of the noise addition processing and the denoising processing can be improved, thereby improving image generation efficiency to some extent.

In operation S707, a process of invoking, in the encoding space, the trained image diffusion sub-model to perform denoising processing on the noise image based on the representation information of the text description information, to obtain the encoding information of the diffusion image corresponding to the sample image is similar to the process of predicting noise in the foregoing embodiment shown in FIG. 3. Specifically, the trained image diffusion sub-model may include N cross-attention modules, and any one of the N cross-attention modules may be represented as an i^{th} cross-attention module. N is an integer greater than or equal to 2, and i is a positive integer less than or equal to N. When i is equal to 1, the i^{th} cross-attention module is invoked to perform correlation calculation on the representation information of the text description information and the noise image, to obtain a cross-attention result of the i^{th} cross-attention module. When i is greater than 1, the i^{th} cross-attention module is invoked to perform correlation calculation on a cross-attention result of an (i−1)^{th} cross-attention module and the representation information of the text description information, to obtain the cross-attention result of the i^{th} cross-attention module. A cross-attention result of an N^{th} cross-attention module is determined as the encoding information of the diffusion image.

In the foregoing operation S705 to operation S707, the application process of the trained image generation model is described in detail. Based on this, two types of application scenarios of the trained image generation model are described. The two types of application scenarios correspond to two types of image generation tasks. Specifically,

if the task type of the image generation task is performing image diffusion based on the whole sample image, the sample category to which the sample image belongs may be a category to which the whole sample image belongs. When the sample category is the category to which the whole sample image belongs, a sample feature of the sample image under the sample category may be a whole image feature of the sample image under the sample category, the training semantics of the sample identifier may be configured for expressing the whole image feature of the sample image under the sample category, and the diffusion image corresponding to the sample image may be an image generated by performing diffusion by using the whole sample image as a diffusion basis. For example, in an image enhancement scenario, a target of the image enhancement scenario is to diffuse a high-quality sample image (for example, an image with higher definition and a fuller image) based on the sample image. In this case, the sample category may be the category (for example, the sample category is a “scenery image”) to which the whole sample image belongs, and the text description information including the sample identifier may be, for example, “a high-quality image of S*”. Based on this, the high-quality sample image may be diffused based on the sample image, thereby facilitating rapid implementation of image enhancement. For another example, in an image inpainting scenario, a target of the image inpainting scenario is to diffuse an inpainted sample image based on the sample image. In this case, the sample category may be the category (for example, the sample category is a “scenery image”) to which the whole sample image belongs, and the text description information including the sample identifier may be, for example, “an inpainted image of S*”. Based on this, the inpainted sample image may be diffused based on the sample image, thereby facilitating rapid implementation of image inpainting. For another example, in an image art creation scenario, a target of image art creation is to diffuse, based on the sample image, an image that has a style similar to a style of the sample image but that has an innovative feature. In this case, the sample category may be the category (for example, the sample category is “oil painting”) to which the whole sample image belongs, and the text description information including the sample identifier may be, for example, “a hybrid ink wash painting of S*”. Based on this, the image that has the style similar to the style of the sample image but that has the innovative feature may be diffused based on the sample image, thereby helping an artist explore a new creation direction and a new expression form.

If the task type of the image generation task is performing image diffusion based on a sample object in the sample image, the sample category to which the sample image belongs may be a category to which the sample object in the sample image belongs. When the sample category is the category to which the sample object in the sample image belongs, the sample feature of the sample image under the sample category may be an object feature of the sample object in the sample image under the sample category, the training semantics of the sample identifier may be configured for expressing the object feature of the sample object in the sample image under the sample category, and the diffusion image corresponding to the sample image may be an image generated by performing diffusion by using the sample object in the sample image as the diffusion basis. For example, in a character design scenario, a target of character design is to diffuse, based on a person object in the sample image, a virtual character corresponding to the person object. In this case, the sample category may be the category (for example, the sample category is a “person”) to which the sample object (for example, the person object) in the sample image belongs, and the text description information including the sample identifier may be, for example, “a cartoon S*”, “a running cartoon S*”, and “a crying S*”. Based on this, a virtual character that is similar to the person object but has different features, actions, expressions, and styles may be diffused based on the person object in the sample image. This is potentially applicable to role playing or animation creation. For another example, in a virtual fitting room scenario, a target of a virtual fitting room is to diffuse a person object wearing different clothes based on the person object in the sample image. In this case, the sample category may be the category (for example, the sample category is a “person”) to which the sample object (for example, the person object) in the sample image belongs, and the text description information including the sample identifier may be, for example, “S* wearing a denim skirt”, “S* wearing a suit”, and “S* wearing marten boots”. Based on this, the person object wearing different clothes may be diffused based on the person object in the sample image, thereby helping preview a clothing effect, and provide personalized shopping advice. For another example, in a personalized commodity customization scenario, a target of a personalized commodity is to diffuse, based on a target object in the sample image, a personalized commodity including the target object. In this case, the sample category may be a category (for example, the sample category is “dog”) to which an animal object (for example, corgi) in the sample image belongs, and the text description information including the sample identifier may be, for example, “a cup including S*”, “a mobile phone case including S*”, and “a T-shirt including S*”. Based on this, a personalized commodity including the animal object may be diffused based on the animal object in the sample image.

In some embodiments, based on two optimization points in a training process of the image generation model (a first optimization point is determining initial representation information of the sample identifier by minimizing, in the first training process of the image generation model, a difference among semantics of the sample image, the semantics of the sample category, and native semantics of the sample identifier. In this way, the training semantics of the sample identifier represented by the determined initial representation information of the sample identifier can be close to the semantics of the sample image and the semantics of the sample category. The initial representation information of the sample identifier is used to participate in the first training on the image generation model. In this way, the image generation model can be quickly guided in a proper training direction, and fitting efficiency of the image generation model and generalization of the image generation model can be improved; and a second optimization point is training the image generation model based on the difference between the training semantics of the sample identifier and the semantics of the sample category, so that a similarity between the training semantics of the sample identifier and the semantics of the sample category can be improved, and the training semantics of the sample identifier is associated with the semantics of the sample category, to better use prior knowledge (for example, the semantics of the sample category) of the image generation model. In this way, an overfitting degree of the image generation model can be reduced, and a training effect of the image generation model can be improved), a capability of combining the sample feature of the sample image under the sample category and text semantics in the text description information can be improved, thereby improving an image generation effect of the trained image generation model.

The following compares, in a form of comparison, a generation effect of the trained image generation model when an optimization point is introduced in the training process of the image generation model with a generation effect of the trained image generation model when no optimization point is introduced in the training process of the image generation model.

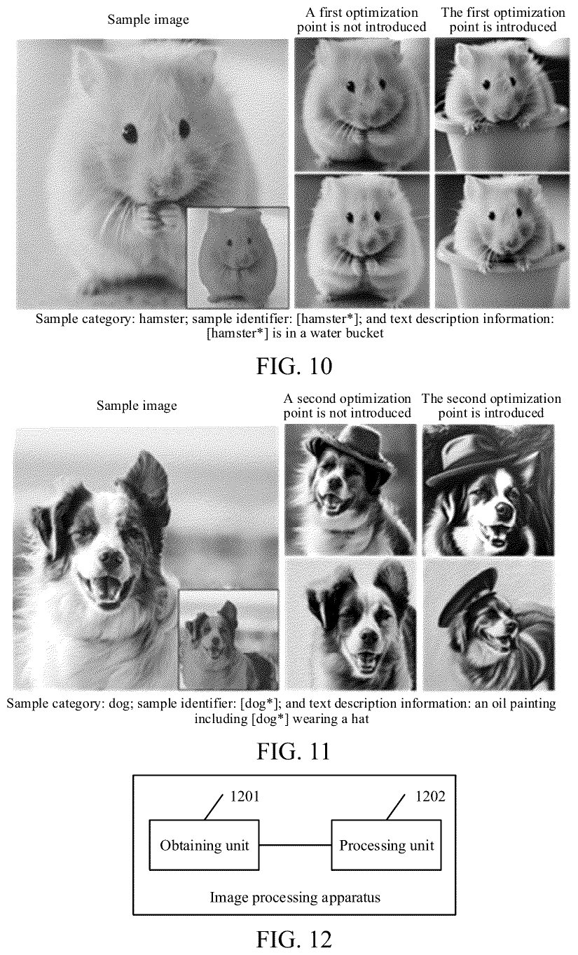

As shown in FIG. 10, a first column of image is a sample image, a sample category to which the sample image belongs is “hamster”, a sample identifier set for the sample image is “[hamster*]”, and text description information including the sample identifier is “[hamster*] is in a water bucket”. A second column shows a generation effect of a trained image generation model when a first optimization point is not introduced in a training process of the image generation model. A third column shows a generation effect of the trained image generation model when the first optimization point is introduced in the training process of the image generation model. The image generation effect of the trained image generation model when the first optimization point is not introduced is obviously worse than the image generation effect of the trained image generation model when the first optimization point is introduced. When the first optimization point is introduced, the image generation model can be quickly guided in a proper training direction, and fitting efficiency of the image generation model and generalization of the image generation model can be improved.

As shown in FIG. 11, a first column of image is a sample image, a sample category to which the sample image belongs is “dog”, a sample identifier set for the sample image is “[dog*]”, and text description information including the sample identifier is “an oil painting including [dog*] wearing a hat”. A second column shows a generation effect of a trained image generation model when a second optimization point is not introduced in a training process of the image generation model. A third column shows a generation effect of the trained image generation model when the second optimization point is introduced in the training process of the image generation model. The image generation effect of the trained image generation model when the second optimization point is not introduced is obviously worse than the image generation effect of the trained image generation model when the second optimization point is introduced. When the second optimization point is introduced, a similarity between training semantics of the sample identifier and semantics of the sample category can be improved, and the training semantics of the sample identifier and the semantics of the sample category can be associated, to better use prior knowledge (for example, the semantics of the sample category) of the image generation model. This can reduce an overfitting degree of the image generation model, and enable the trained image processing model to better combine a sample feature of the sample image under the sample category with text semantics of the text description information, so that a generated image is more natural and diversified.

FIG. 12 is a schematic structural diagram of an image processing apparatus according to some embodiments. Referring to FIG. 12, the image processing apparatus may include the following units:
an obtaining unit 1201, configured to obtain sample data configured for training an image generation model, the sample data including a sample image, a sample category to which the sample image belongs, and a sample identifier set for the sample image;
a processing unit 1202, configured to invoke the image generation model to extract training representation information of the sample identifier, the training representation information of the sample identifier being configured for representing training semantics of the sample identifier, and the training semantics of the sample identifier being configured for expressing a sample feature of the sample image under the sample category;
the processing unit 1202, further configured to invoke the image generation model to predict, based on the training representation information of the sample identifier, noise added to a noise image corresponding to the sample image, to obtain predicted noise, the noise image being obtained by performing noise addition processing on the sample image, and noise added in the noise addition processing being marked noise; and
the processing unit 1202, further configured to update a model parameter of the image generation model based on a difference between the marked noise and the predicted noise and a difference between the training semantics of the sample identifier and semantics of the sample category, to train the image generation model, the trained image generation model being configured to perform denoising processing on the noise image based on text description information including the sample identifier, to generate a diffusion image related to semantics of the text description information.

In an implementation, training operations of extracting the training representation information of the sample identifier, predicting the noise added to the noise image, and updating the model parameter of the image generation model are configured for training the image generation model once. The processing unit 1202 is further configured to perform the following operations:
performing iterative training on the image generation model based on the training operations until a training termination condition is satisfied, to obtain the trained image generation model; and
using, in an iterative training process of the image generation model, initial representation information of the sample identifier as a training starting point, the initial representation information of the sample identifier being determined by minimizing a difference among semantics of the sample image, the semantics of the sample category, and native semantics of the sample identifier, and the training starting point referring to: using the initial representation information of the sample identifier as the training representation information of the sample identifier, to participate in a first training process of the image generation model.

In an implementation, in the iterative training process of the image generation model, noise images corresponding to the sample image used in each training process of the image generation model are different; and the noise images corresponding to the sample image being different means that: marked noise added when noise addition processing is performed on the sample image in each training process of the image generation model is different, where
the marked noise being different includes any one of the following: the marked noise added in each training process of the image generation model is of different types, or the marked noise added in each training process of the image generation model is of the same type but has different strength.

In an implementation, when configured to determine the initial representation information of the sample identifier by minimizing the difference among the semantics of the sample image, the semantics of the sample category, and the native semantics of the sample identifier, the processing unit 1202 is configured to perform the following operations:
extracting representation information of the sample image, the representation information of the sample image being configured for representing the semantics of the sample image;
extracting representation information of the sample category, the representation information of the sample category being configured for representing the semantics of the sample category;
performing averaging processing on the representation information of the sample image and the representation information of the sample category, to obtain average representation information;
extracting native representation information of the sample identifier, the native representation information of the sample identifier being configured for representing the native semantics of the sample identifier; and
determining the initial representation information of the sample identifier by minimizing a distance between the native representation information of the sample identifier and the average representation information.

In an implementation, when configured to extract the representation information of the sample image, the processing unit 1202 is configured to perform the following operations:
extracting original image representation information of the sample image, the original image representation information being configured for representing original image semantics of the sample image;
extracting background removing representation information of a background removing image corresponding to the sample image, the background removing representation information being configured for representing semantics of the background removing image; and
determining the original image representation information and the background removing representation information as the representation information of the sample image.

In an implementation, the image generation model includes a text encoder and an image diffusion sub-model, the text encoder is configured to extract the training representation information of the sample identifier, and the image diffusion sub-model is configured to predict noise. A training module is added to the text encoder and the image diffusion sub-model.

When configured to update the model parameter of the image generation model based on the difference between the marked noise and the predicted noise and the difference between the training semantics of the sample identifier and the semantics of the sample category, to train the image generation model, the processing unit 1202 is configured to perform the following operations:
keeping, based on the difference between the marked noise and the predicted noise and the difference between the training semantics of the sample identifier and the semantics of the sample category, an original model parameter in the text encoder and the image diffusion sub-model unchanged, and updating a model parameter of the training module added to the text encoder and the image diffusion sub-model, to train the image generation model.

In an implementation, the image diffusion sub-model in the image generation model is invoked to predict the noise added to the noise image. The image diffusion sub-model includes N cross-attention modules, and any one of the N cross-attention modules is represented as an i^{th} cross-attention module. N is an integer greater than or equal to 2, and i is a positive integer less than or equal to N.

When configured to invoke the image generation model to predict, based on the training representation information of the sample identifier, the noise added to the noise image corresponding to the sample image, to obtain the predicted noise, the processing unit 1202 is configured to perform the following operations:
invoking, when i is equal to 1, the i^{th} cross-attention module to perform correlation calculation on the training representation information of the sample identifier and the noise image, to obtain a cross-attention result of the i^{th} cross-attention module;
invoking, when i is greater than 1, the i^{th} cross-attention module to perform correlation calculation on a cross-attention result of an (i−1)^{th} cross-attention module and the training representation information of the sample identifier, to obtain the cross-attention result of the i^{th} cross-attention module; and
determining a cross-attention result of an N^{th} cross-attention module as the predicted noise.

In an implementation, the trained image generation model includes a trained text encoder and a trained image diffusion sub-model. The obtaining unit 1201 is further configured to perform the following operation:
obtaining the text description information including the sample identifier.

The processing unit 1202 is further configured to perform the following operations:
invoking the trained text encoder to extract representation information of the text description information, the representation information of the text description information being configured for expressing semantics of the text description information; and
invoking the trained image diffusion sub-model to perform denoising processing on the noise image based on the representation information of the text description information, to generate a diffusion image corresponding to the sample image, the diffusion image being related to the semantics of the text description information.

In an implementation, the noise image is obtained by performing noise addition processing in an encoding space after the sample image is converted from a pixel space to the encoding space. When configured to invoke the trained image diffusion sub-model to perform denoising processing on the noise image based on the representation information of the text description information, to generate the diffusion image corresponding to the sample image, the processing unit 1202 is configured to perform the following operations:
invoking, in the encoding space, the trained image generation model to perform denoising processing on the noise image based on the representation information of the text description information, to obtain encoding information of the diffusion image; and
converting the encoding information of the diffusion image from the encoding space to the pixel space, to obtain the diffusion image.

In an implementation, when the sample category is a category to which the whole sample image belongs, the sample feature of the sample image under the sample category is a whole image feature of the sample image under the sample category, the training semantics of the sample identifier is configured for expressing the whole image feature of the sample image under the sample category, and the diffusion image corresponding to the sample image is an image generated by performing diffusion by using the whole sample image as a diffusion basis.

When the sample category is a category to which a sample object in the sample image belongs, the sample feature of the sample image under the sample category is an object feature of the sample object in the sample image under the sample category, the training semantics of the sample identifier is configured for expressing the object feature of the sample object in the sample image under the sample category, and the diffusion image corresponding to the sample image is an image generated by performing diffusion by using the sample object in the sample image as the diffusion basis.

According to some embodiments, units of the image processing apparatus shown in FIG. 12 may be respectively or wholly combined into one or a plurality of other units, or one (or more) of the units here may be further divided into the plurality of units of smaller functions. In this way, same operations can be implemented, and implementation of the technical effects of embodiments of this application is not affected. The foregoing units are divided based on logical functions. In actual application, a function of one unit may also be implemented by a plurality of units, or functions of the plurality of units may be implemented by one unit. In some embodiments, the image processing apparatus may also include another unit. In actual application, these functions may also be cooperatively implemented by another unit, and may be cooperatively implemented by the plurality of units.

According to some embodiments, a computer program that can perform some or all of the operations involved in the method shown in FIG. 3 or FIG. 7 may be run in a general-purpose computing device such as a computer including processing elements and storage elements such as a central processing unit (CPU), a random access memory (RAM), and a read-only memory (ROM), to construct the image processing apparatus shown in FIG. 12, thereby implementing the image processing method in some embodiments. The computer program may be recorded on, for example, a computer-readable storage medium, loaded into the foregoing computing device through the computer-readable storage medium, and run in the computing device.

In some embodiments, in a process of training the image generation model by using a single sample image, the sample identifier may be set for the sample image. The training semantics of the sample identifier may be configured for expressing the sample feature of the sample image under the sample category. The model parameter of the image generation model is updated based on the difference between the training semantics of the sample identifier and the semantics of the sample category, to train the image generation model. In this way, a similarity between the training semantics of the sample identifier and the semantics of the sample category can be improved. In other words, a similarity between the sample feature of the sample image under the sample category and the semantics of the sample category can be improved. This helps reduce an overfitting degree of the image generation model and improve a training effect of the image generation model.

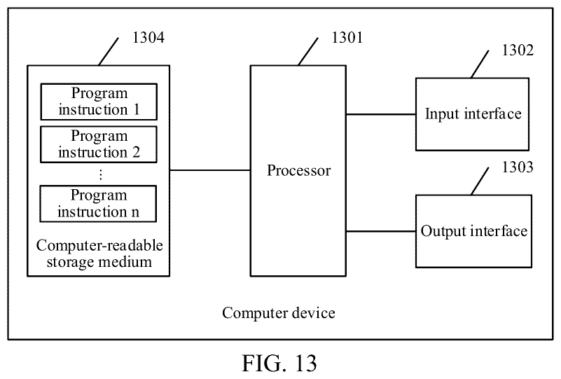

Based on the foregoing method and apparatus embodiments, some embodiments provides a computer device. FIG. 13 is a schematic structural diagram of a computer device according to some embodiments. The computer device shown in FIG. 13 includes at least a processor 1301, an input interface 1302, an output interface 1303, and a computer-readable storage medium 1304. The processor 1301, the input interface 1302, the output interface 1303, and the computer-readable storage medium 1304 may be connected through a bus or in another manner.

The computer-readable storage medium 1304 may be stored in a memory of the computer device. The computer-readable storage medium 1304 is configured to store a computer program. The computer program includes computer instructions. The processor 1301 is configured to execute the computer program stored in the computer-readable storage medium 1304. The processor 1301 (or referred to as a central processing unit (CPU)) is a computing core and a control core of the computer device, is suitable for implementing the computer program, and is suitable for loading and executing the computer program to implement a corresponding method procedure or a corresponding function.

Some embodiments further provide a computer-readable storage medium (memory). The computer-readable storage medium is a memory device in a computer device and is configured to store a program and data. The computer-readable storage medium herein may include a built-in storage medium in the computer device, and certainly, may also include an extended storage medium supported by the computer device. The computer-readable storage medium provides a storage space. The storage space has an operating system of the computer device stored therein. In addition, the storage space further stores a computer program suitable to be loaded and executed by a processor. The computer-readable storage medium herein may be a high-speed RAM, or may be a non-volatile memory, for example, at least one magnetic disk memory. In some embodiments, the computer-readable storage medium may be further at least one computer-readable storage medium that is located far away from the foregoing processor.

The computer device may be, for example, the integrated device of the model training device and the model application device in the image processing system shown in FIG. 2. During specific implementation, the computer program stored in the computer-readable storage medium 1304 may be loaded and executed by the processor 1301, to implement the foregoing corresponding operations of the image processing method shown in FIG. 3 or FIG. 7.

According to an aspect of this application, a computer program product is provided. The computer program product includes a computer program, and the computer program is stored in a computer-readable storage medium. A processor of a computer device reads the computer program from the computer-readable storage medium, and the processor executes the computer program, to cause the computer device to perform the image processing method provided in the foregoing various implementations.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

According to some embodiments, each module or unit may exist respectively or be combined into one or more units. Some units may be further split into multiple smaller function subunits, thereby implementing the same operations without affecting the technical effects of some embodiments. The units are divided based on logical functions. In actual applications, a function of one unit may be realized by multiple units, or functions of multiple units may be realized by one unit. In some embodiments, the apparatus may further include other units. These functions may also be realized cooperatively by the other units, and may be realized cooperatively by multiple units.

A person skilled in the art would understand that these “modules” could be implemented by hardware logic, a processor or processors executing computer software code, or a combination of both. The “modules” may also be implemented in software stored in a memory of a computer or a non-transitory computer-readable medium, where the instructions of each module are executable by a processor to thereby cause the processor to perform the respective operations of the corresponding module.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. An image processing method, performed by a computer device, and the method comprising:
obtaining sample data for training an image generation model, the sample data comprising a sample image, a sample category to which the sample image belongs, and a sample identifier set for the sample image;
extracting training representation information of the sample identifier, the training representation information representing training semantics of the sample identifier that express a sample feature of the sample image under the sample category;
generating a noise image by adding marked noise to encoding information of the sample image;
predicting, based on the training representation information, noise in the noise image to obtain predicted noise; and
updating at least one model parameter of the image generation model based on a difference between the marked noise and the predicted noise and a difference between the training semantics of the sample identifier and semantics of the sample category, to train the image generation model,
wherein the trained image generation model is configured to perform denoising processing on the noise image based on text description information including the sample identifier, to generate a diffusion image.

2. The method according to claim 1, further comprising:
performing iterative training on the image generation model until a training termination condition is satisfied, to obtain the trained image generation model;
determining initial representation information of the sample identifier by minimizing a difference among semantics of the sample image, semantics of the sample category, and native semantics of the sample identifier;
using the initial representation information as the training representation information in a first training iteration of the image generation model;
using, in an iterative training, initial representation information of the sample identifier as a training starting point.

3. The method according to claim 2,
wherein the determining comprises:
extracting representation information of the sample image, the representation information of the sample image representing the semantics of the sample image;
extracting representation information of the sample category, the representation information of the sample category representing the semantics of the sample category;
performing averaging processing on the representation information of the sample image and the representation information of the sample category, to obtain average representation information;
extracting native representation information of the sample identifier, the native representation information of the sample identifier representing the native semantics of the sample identifier; and
determining the initial representation information of the sample identifier by minimizing a distance between the native representation information of the sample identifier and the average representation information.

4. The method according to claim 3, wherein the extracting representation information of the sample image comprises:
extracting original image representation information of the sample image, the original image representation information representing original image semantics of the sample image;
extracting background removing representation information of a background removing image corresponding to the sample image, the background removing representation information representing semantics of the background removing image; and
determining the original image representation information and the background removing representation information as the representation information of the sample image.

5. The method according to claim 1,
wherein the image generation model comprises a text encoder configured to extract the training representation information of the sample identifier and an image diffusion sub-model configured to predict noise, and a training layer is added to the text encoder and the image diffusion sub-model,
wherein the updating at least one model parameter comprises:
keeping, based on the difference between the marked noise and the predicted noise and the difference between the training semantics of the sample identifier and the semantics of the sample category, an original model parameter in the text encoder and the image diffusion sub-model unchanged; and
updating at least one model parameter of the training layer added to the text encoder and the image diffusion sub-model, to train the image generation model.

6. The method according to claim 1,
wherein an image diffusion sub-model in the image generation model is used to predict the noise in the noise image,
wherein the image diffusion sub-model comprises N cross-attention layers, Nis an integer greater than or equal to 2,
wherein the predicting the noise comprises:
for a first cross-attention layer, computing a first cross-attention result between the training representation information and the noise image;
for each subsequent cross-attention layer, computing a subsequent cross-attention result between an output of a preceding cross-attention layer and the training representation information; and
outputting a final cross-attention result from an Nth cross-attention layer as the predicted noise.

7. The method according to claim 1,
wherein the trained image generation model comprises a trained text encoder and a trained image diffusion sub-model, and
wherein the method further comprises:
obtaining the text description information comprising the sample identifier;
extract representation information of the text description information by using the trained text encoder, the representation information of the text description information expressing semantics of the text description information; and
perform, by using the trained image diffusion sub-model, denoising on the noise image based on the representation information of the text description information, to generate a diffusion image corresponding to the sample image and associated with the semantics of the text description information.

8. The method according to claim 7,
wherein the noise image is obtained by performing noise addition processing in an encoding space in a case that the sample image is converted from a pixel space to the encoding space,
wherein the performing denoising processing comprises:
perform, by the trained image generation model in the encoding space, denoising processing on the noise image based on the representation information of the text description information, to obtain encoding information of the diffusion image; and
converting the encoding information of the diffusion image from the encoding space to the pixel space, to obtain the diffusion image.

9. The method according to claim 1,
wherein in a case that the sample category is a category to which the whole sample image belongs,
the sample feature is a whole image feature of the sample image,
the training semantics expresses the whole image feature, and
the diffusion image is generated based on using the whole sample image as a diffusion basis; and
wherein in a case that the sample category is a category to which a sample object in the sample image belongs,
the sample feature is an object feature of the sample object in the sample image,
the training semantics expresses the object feature of the sample object, and
the diffusion image is generated by performing diffusion based on using the sample object in the sample image as the diffusion basis.

10. The method according to claim 2,
wherein in the iterative training, noise images corresponding to the sample image used in each training process of the image generation model are different,
wherein the marked noise added during noise addition processing in each training process is different, and
wherein the marked noise comprises at least one of:
the marked noise added in each training process is of different types, or
the marked noise added in each training process is of a same type but has different strength.

11. An image processing apparatus, comprising:
at least one memory configured to store program code; and
at least one processor configured to read the program code and operate as instructed by the program code, the program code comprising:
obtaining code configured to cause at least one of the at least one processor to obtain sample data for training an image generation model, the sample data comprising a sample image, a sample category to which the sample image belongs, and a sample identifier set for the sample image;
extracting code configured to cause at least one of the at least one processor to extract training representation information of the sample identifier, the training representation information representing training semantics of the sample identifier that express a sample feature of the sample image under the sample category;
generating code configured to cause at least one of the at least one processor to generate a noise image by adding marked noise to encoding information of the sample image;
predicting code configured to cause at least one of the at least one processor to predict, based on the training representation information, noise in the noise image to obtain predicted noise; and
updating code configured to cause at least one of the at least one processor to update at least one model parameter of the image generation model based on a difference between the marked noise and the predicted noise and a difference between the training semantics of the sample identifier and semantics of the sample category, to train the image generation model,
wherein the trained image generation model is configured to perform denoising processing on the noise image based on text description information including the sample identifier, to generate a diffusion image.

12. The apparatus according to claim 11, wherein the program code further comprises:
training code configured to cause at least one of the at least one processor to perform iterative training on the image generation model until a training termination condition is satisfied, to obtain the trained image generation model;
determining code configured to cause at least one of the at least one processor to determine initial representation information of the sample identifier by minimizing a difference among semantics of the sample image, semantics of the sample category, and native semantics of the sample identifier;
wherein the training code is further configured to cause at least one of the at least one processor to use the initial representation information as the training representation information in a first training iteration of the image generation model;
wherein the training code is further configured to cause at least one of the at least one processor to use, in an iterative training, initial representation information of the sample identifier as a training starting point.

13. The apparatus according to claim 12,
wherein the determining code is further configured to cause at least one of the at least one processor to:
extract representation information of the sample image, the representation information of the sample image representing the semantics of the sample image;
extract representation information of the sample category, the representation information of the sample category representing the semantics of the sample category;
perform averaging processing on the representation information of the sample image and the representation information of the sample category, to obtain average representation information;
extract native representation information of the sample identifier, the native representation information of the sample identifier representing the native semantics of the sample identifier; and
determine the initial representation information of the sample identifier by minimizing a distance between the native representation information of the sample identifier and the average representation information.

14. The apparatus according to claim 13, wherein the determining code is further configured to cause at least one of the at least one processor to:
extract original image representation information of the sample image, the original image representation information representing original image semantics of the sample image;
extract background removing representation information of a background removing image corresponding to the sample image, the background removing representation information representing semantics of the background removing image; and
determine the original image representation information and the background removing representation information as the representation information of the sample image.

15. The apparatus according to claim 11,
wherein the image generation model comprises a text encoder configured to extract the training representation information of the sample identifier and an image diffusion sub-model configured to predict noise, and a training layer is added to the text encoder and the image diffusion sub-model,
wherein the updating code is further configured to cause at least one of the at least one processor to:
keep, based on the difference between the marked noise and the predicted noise and the difference between the training semantics of the sample identifier and the semantics of the sample category, an original model parameter in the text encoder and the image diffusion sub-model unchanged; and
update at least one model parameter of the training layer added to the text encoder and the image diffusion sub-model, to train the image generation model.

16. The apparatus according to claim 11,
wherein an image diffusion sub-model in the image generation model is used to predict the noise in the noise image,
wherein the image diffusion sub-model comprises N cross-attention layers, N is an integer greater than or equal to 2,
wherein the predicting code is further configured to cause at least one of the at least one processor to:
for a first cross-attention layer, compute a first cross-attention result between the training representation information and the noise image;
for each subsequent cross-attention layer, compute a subsequent cross-attention result between an output of a preceding cross-attention layer and the training representation information; and
output a final cross-attention result from an Nth cross-attention layer as the predicted noise.

17. The apparatus according to claim 11,
wherein the trained image generation model comprises a trained text encoder and a trained image diffusion sub-model, and
wherein the program code further comprises:
description code configured to cause at least one of the at least one processor to obtain the text description information comprising the sample identifier;
representation code configured to cause at least one of the at least one processor to extract representation information of the text description information by using the trained text encoder, the representation information of the text description information expressing semantics of the text description information; and
denoising code configured to cause at least one of the at least one processor to perform, by using the trained image diffusion sub-model, denoising on the noise image based on the representation information of the text description information, to generate a diffusion image corresponding to the sample image and associated with the semantics of the text description information.

18. The apparatus according to claim 17,
wherein the noise image is obtained by performing noise addition processing in an encoding space in a case that the sample image is converted from a pixel space to the encoding space,
wherein the denoising code is further configured to cause at least one of the at least one processor to:
perform, by the trained image generation model in the encoding space, denoising processing on the noise image based on the representation information of the text description information, to obtain encoding information of the diffusion image; and
convert the encoding information of the diffusion image from the encoding space to the pixel space, to obtain the diffusion image.

19. The apparatus according to claim 11,
wherein in a case that the sample category is a category to which the whole sample image belongs,
the sample feature is a whole image feature of the sample image,
the training semantics expresses the whole image feature, and
the diffusion image is generated based on using the whole sample image as a diffusion basis; and
wherein in a case that the sample category is a category to which a sample object in the sample image belongs,
the sample feature is an object feature of the sample object in the sample image,
the training semantics expresses the object feature of the sample object, and
the diffusion image is generated by performing diffusion based on using the sample object in the sample image as the diffusion basis.

20. A non-transitory computer-readable storage medium, storing computer code which, when executed by at least one processor, causes the at least one processor to at least:
obtain sample data for training an image generation model, the sample data comprising a sample image, a sample category to which the sample image belongs, and a sample identifier set for the sample image;
extract training representation information of the sample identifier, the training representation information representing training semantics of the sample identifier that express a sample feature of the sample image under the sample category;
generate a noise image by adding marked noise to encoding information of the sample image;
predict, based on the training representation information, noise in the noise image to obtain predicted noise; and
update at least one model parameter of the image generation model based on a difference between the marked noise and the predicted noise and a difference between the training semantics of the sample identifier and semantics of the sample category, to train the image generation model,
wherein the trained image generation model is configured to perform denoising processing on the noise image based on text description information including the sample identifier, to generate a diffusion image.
